(19) United States
(12) Patent Application Publication
(10) Pub. No.: US 2013/0215860 A1
(43) Pub. Date: Aug. 22, 2013

(54) METHOD OF TRANSMITTING AND RECEIVING DATA IN A MULTI RADIO ACCESS TECHNOLOGY SYSTEM AND APPARATUS THEREFOR

(71) Applicants: Heejeong Cho, Anyang-si (KR); Eunjong Lee, Anyang-si (KR); Youngsoo Yuk, Anyang-si (KR); Jin Lee, Anyang-si (KR)

(72) Inventors: Heejeong Cho, Anyang-si (KR); Eunjong Lee, Anyang-si (KR); Youngsoo Yuk, Anyang-si (KR); Jin Lee, Anyang-si (KR)

(73) Assignee: LG ELECTRONICS INC., Seoul (KR)

(21) Appl. No.: 13/880,692

(22) PCT Filed: Oct. 20, 2011
(86) PCT No.: PCT/KR2011/007846

§ 371 Date: Apr. 19, 2013

Related U.S. Application Data
(60) Provisional application No. 61/394,779, filed on Oct. 20, 2010.
(60) Provisional application No. 61/418,410, filed on Dec. 1, 2010.

(30) Foreign Application Priority Data
Oct. 20, 2011 (KR) 10-2011-0107313

(51) Int. Cl. H04W 88/04

(52) U.S. Cl. CPC H04W 88/04
USPC 370/329

(57) ABSTRACT

A method of performing a wireless communication, which is performed by a user equipment supporting a Multi-RAT (Radio Access Technology), includes receiving a notification signal indicating an existence of at least one cooperative user equipment candidate from the at least one cooperative user equipment candidate for a client cooperation (CC) via a first radio access scheme and transmitting a first data to a base station using at least one cooperative user equipment connected via the received notification signal among the at least one cooperative user equipment candidate. In this case, the first data is exchanged between the user equipment and the at least one cooperative user equipment via the first radio access scheme and the first data is exchanged between the at least one cooperative user equipment and the base station via a second radio access scheme.

### TECHNICAL FIELD

The present invention relates to a wireless communication, and more particularly, to a method for a base station and a user equipment to transmit and receive data in a multi radio access technology system and apparatus therefor.

### BACKGROUND ART

Recently, data traffic on a wireless communication network is increasing fast. This fast increasing data traffic is attributed to the advent and propagation of such a device requiring machine-to-machine (M2M) communication and high data traffic as a smart phone, a tablet PC and the like. In order to meet the required high data traffic, carrier aggregation (hereinafter abbreviated CA) by using more frequency bands efficiently, cognitive radio technology, MIMO technology for increasing data size within a limited frequency, multiple base station cooperative transmission technology and the like are getting the spotlight.

As ubiquitous environment has come, there is ongoing demand for receiving a seamless service irrespective of time and place using equipments.

Therefore, a wireless communication network establishes a cooperative system among a plurality of user equipments communicating with each other via a base station and has been making progress to enable at least one or more user equipments to transmit/receive data to/from a base station in accordance with the communication environment.

In this case, a plurality of the user equipments may include a source device as a subject to communicate with a base station with helps of other user equipments connected to the source device, a cooperative device playing a role as a relay to help a source device to communicate with a base station and a cooperative device candidate except a source device playing a role as a cooperative device.

A wireless communication system provided with user equipments in high density may be able to give higher system performance by the cooperation among the user equipments. For instance, in case of attempting to transmit prescribed data to a base station, a source device may transmit the data together with a cooperative device. Moreover, the source device may be able to transmit the data via the cooperative device. The above-described example may be identically applicable to a case that a base station transmits data to a user equipment, by which further excellent system performance may be accomplished. In the following description, a wireless communication system including a plurality of user equipments having established a cooperative system may be named a multi radio access technology (RAT) system.

However, since a source device has mobility, it may be necessary to periodically or aperiodically update information on a plurality of cooperative device candidates existing positions close to the source device. And, the demand for a corresponding solution is rising.

### DISCLOSURE OF INVENTION

### Technical Problem

Accordingly, the present invention is directed to a wireless communication, and more particularly, to a method for a base station and a user equipment to transmit and receive data in a multi radio access technology system and apparatus therefore, which may substantially obviate one or more of the problems due to limitations and disadvantages of the related art.

An object of the present invention is to provide a method for a user equipment supporting a multi-RAT (multi-radio access technology) to perform a communication.

Another object of the present invention is to provide a method for a cooperative user equipment supporting a multi-RAT (multi-radio access technology) to perform a communication.

Another object of the present invention is to provide a method for a base station supporting a multi-RAT (multi-radio access technology) to perform a communication.

Another object of the present invention is to provide a user equipment supporting a multi-RAT (multi-radio access technology).

Another object of the present invention is to provide a cooperative user equipment candidate supporting a multi-RAT (multi-radio access technology).

A further object of the present invention is to provide a base station supporting a multi-RAT (multi-radio access technology).

Technical tasks obtainable from the present invention are non-limited the above mentioned effect. And, other unmentioned technical tasks s can be clearly understood from the following description by those having ordinary skill in the technical field to which the present invention pertains.

### Solution to Problem

Additional features and advantages of the invention will be set forth in the description which follows, and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, a method of performing a communication, which is performed by a user equipment supporting a multi-RAT (multi-radio access technology, according to one embodiment of the present invention may include the steps of receiving a notification signal indicating an existence of at least one cooperative user equipment candidate from the at least one cooperative user equipment candidate for a client cooperation (CC) via a 1^{st} radio access scheme and transmitting a 1^{st} data to a base station using at least one cooperative user equipment connected via the received notification signal among the at least one cooperative user equipment candidate, wherein the 1^{st} data is exchanged between the user equipment and the at least one cooperative user equipment via the 1^{st} radio access scheme and wherein the 1^{st} data is exchanged between the at least one cooperative user equipment and the base station via a 2^{nd} radio access scheme.

Preferably, the method may further include the step of directly transmitting a 2^{nd} data to the base station from the user equipment via the 2^{nd} radio access scheme.

Preferably, the 1^{st} radio access scheme may include WiFi (wireless fidelity) access scheme and the 2^{nd} radio access scheme may include WiMAX (worldwide interoperability for microwave access) scheme.

Preferably, the at least one cooperative user equipment candidate may be determined by the base station.

More preferably, the at least one cooperative user equipment candidate may be determined by the base station using at least one selected from the group consisting of information on whether a client cooperation operation is be supportable, moving speed information, location information, information on a presence or non-presence of neighbor cooperative user equipment candidate(s) in the vicinity and the number of the neighbor cooperative user equipment candidate(s), retained power information, and channel status information.

Preferably, the notification signal of each of the at least one cooperative user equipment candidate may be discriminated by being received at a different time.

Preferably, the notification signal may be received as a type of an RTS (ready to send) frame including an RA (receiver address) field and a TA (transmitter address) field, the RA field may be set to an address value previously assigned to discriminate the at least one cooperative user equipment candidate from each other, and the TA field may be set to a MAC (medium access control) address value of each of the at least one cooperative user equipment candidate.

Preferably, the method may further include the step of periodically monitoring whether the notification signal is received.

Preferably, the method may further include the step of transmitting the received notification signal to the base station from the user equipment and the received notification signal may be transmitted periodically or in response to a request received from the base station.

To further achieve these and other advantages and in accordance with the purpose of the present invention, a method of performing a communication, which is performed by a cooperative user equipment candidate supporting a multi-RAT (multi-radio access technology, according to one embodiment of the present invention may include the steps of transmitting a notification signal indicating an existence of the cooperative user equipment candidate to a user equipment for a client cooperation (CC) via a 1^{st} radio access scheme, receiving a 1^{st} data from the user equipment connected via the transmitted notification signal, and transmitting the received 1^{st} data to a base station, wherein the 1^{st} data is exchanged between the user equipment and the cooperative user equipment candidate via the 1^{st} radio access scheme and wherein the 1^{st} data is exchanged between the cooperative user equipment candidate and the base station via a 2^{nd} radio access scheme.

Preferably, the method may further include the step of receiving an activation request message for the client cooperation from the base station and the notification signal may be transmitted to the user equipment in response to the activation request message.

Preferably, the method may further include the step of receiving time information for transmitting the notification signal from the base station and the notification signal may be transmitted to the user equipment in accordance with the received time information.

Preferably, the notification signal may be transmitted as a type of an RTS (ready to send) frame including an RA (receiver address) field and a TA (transmitter address) field, the RA field may be set to an address value previously assigned to discriminate the cooperative user equipment candidate and a another cooperative user equipment candidate from each other, and the TA field may be set to a MAC (medium access control) address value of each of the cooperative user equipment candidate.

To further achieve these and other advantages and in accordance with the purpose of the present invention, a method of performing a communication, which is performed by a base station supporting a multi-RAT (multi-radio access technology, according to one embodiment of the present invention may include the steps of transmitting an activation request message for a client cooperation (CC) to at least one cooperative user equipment candidate via a 2^{nd} radio access scheme and receiving a 1^{st} data using at least one cooperative user equipment connected to the user equipment via a notification signal for the client cooperation (CC) among the at least one cooperative user equipment candidate, wherein the 1^{st} data is exchanged between the user equipment and the cooperative user equipment via a 1^{st} radio access scheme and wherein the 1^{st} data is exchanged between the at least one cooperative user equipment and the base station via the 2^{nd} radio access scheme.

Preferably, the method may further include the step of directly receiving a 2^{nd} data from the user equipment via the 2^{nd} radio access scheme.

Preferably, the at least one cooperative user equipment candidate may be determined by the base station using at least one selected from the group consisting of information on whether a client cooperation operation is be supportable, moving speed information, location information, information on a presence or non-presence of neighbor cooperative user equipment candidate(s) in the vicinity and the number of the neighbor cooperative user equipment candidate(s), retained power information, and channel status information.

Preferably, the method may further include the step of transmitting a time information for transmitting the notification signal of each of the at least one cooperative user equipment candidate to the at least one cooperative user equipment candidate via the 2^{nd} radio access scheme and the notification signal of each of the at least one cooperative user equipment candidate may be discriminated by being transmitted at a different time in accordance with the time information.

To further achieve these and other advantages and in accordance with the purpose of the present invention, a user equipment, which supports a multi-RAT (multi-radio access technology, according to one embodiment of the present invention may include may include a receiving module receiving a notification signal indicating an existence of at least one cooperative user equipment candidate from the at least one cooperative user equipment candidate for a client cooperation (CC) via a 1^{st} radio access scheme, a transmitting module transmitting a 1^{st} data to a base station using at least one cooperative user equipment connected via the received notification signal among the at least one cooperative user equipment candidate, and a processor controlling the 1^{st} data to be exchanged between the user equipment and the at least one cooperative user equipment via the 1^{st} radio access scheme, the processor controlling the 1^{st} data to be exchanged between the at least one cooperative user equipment and the base station via a 2^{nd} radio access scheme.

To further achieve these and other advantages and in accordance with the purpose of the present invention, a cooperative user equipment candidate, which supports a multi-RAT (multi-radio access technology, according to one embodiment of the present invention may include a transmitting module transmitting a notification signal indicating an existence of the cooperative user equipment candidate to a user equipment for a client cooperation (CC) via a 1^{st} radio access scheme, a receiving module receiving a 1^{st} data from the user equipment connected via the transmitted notification signal, and a processor controlling the received 1^{st} data to be transmitted to a base station via the transmitting module, the processor controlling the 1^{st} data to be exchanged between the user equipment and the cooperative user equipment candidate via the 1^{st} radio access scheme, the processor controlling the 1^{st} data to be exchanged between the cooperative user equipment candidate and the base station via a 2^{nd} radio access scheme.

To further achieve these and other advantages and in accordance with the purpose of the present invention, a base station, which supports a multi-RAT (multi-radio access technology, according to one embodiment of the present invention may include a transmitting module transmitting an activation request message for a client cooperation (CC) to at least one cooperative user equipment candidate via a 2^{nd} radio access scheme, a receiving module receiving a 1^{st} data using at least one cooperative user equipment connected to the user equipment via a notification signal for the client cooperation (CC) among the at least one cooperative user equipment candidate, and a processor controlling the 1^{st} data to be exchanged between the user equipment and the cooperative user equipment via a 1^{st} radio access scheme, the processor controlling the 1^{st} data to be exchanged between the at least one cooperative user equipment and the base station via the 2^{nd} radio access scheme.

It is to be understood that both the foregoing general description and the following detailed description are exemplary and explanatory and are intended to provide further explanation of the invention as claimed.

### Advantageous Effects of Invention

Accordingly, the present invention provides the following effects and/or advantages.

First of all, a base station in a multi-RAT (multi-radio access technology) may be able to effectively transmit data to a source device according to the contents of the present invention.

Secondly, a source device in a multi-RAT (multi-radio access technology) may be able to effectively transmit data to a base station via a cooperative device according to the contents of the present invention.

Effects obtainable from the present invention are non-limited the above mentioned effect. And, other unmentioned effects can be clearly understood from the following description by those having ordinary skill in the technical field to which the present invention pertains.

### BRIEF DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a diagram for one example of a multi-RAT (multi-radio access technology) system;

FIG. 2 is a diagram for one example of an operation of a multi-RAT (multi-radio access technology) system;

FIG. 3 is a diagram for a structure of FDD (frequency division duplex) radio frame in 3GPP LTE;

FIG. 4 is a diagram for a structure of TDD (time division duplex) radio frame in 3GPP LTE;

FIG. 5 is a diagram for one example of a resource grid for one downlink slot;

FIG. 6 is a diagram for one example of a structure of a downlink frame;

FIG. 7 is a diagram for a structure of an uplink subframe used in LTE system;

FIG. 8 is a diagram for explaining mapping relations among a code word, a layer and an antenna to transmit a downlink signal in a multi-RAT (multi-radio access technology) system;

FIG. 9 is a diagram for one example of an information exchanging step requested to transmit/receive data between a base station and a plurality of devices in a multi-RAT (multi-radio access technology) system according to the present invention;

FIG. 10 is a diagram for a detailed example of a transmission period of a notification signal according to the present invention;

FIG. 11 is a diagram for one example of a transmission frame of a notification signal according to the present invention; and

FIG. 12 is a block diagram for one example of a base station and a user equipment according to the present invention.

### MODE FOR THE INVENTION

Reference will now be made in detail to the preferred embodiments of the present invention, examples of which are illustrated in the accompanying drawings. Wherever possible, the same reference numbers will be used throughout the drawings to refer to the same or like parts.

First of all, the following description of the present invention may be usable for various wireless access schemes including CDMA (code division multiple access), FDMA (frequency division multiple access), TDMA (time division multiple access), OFDMA (orthogonal frequency division multiple access), SC-FDMA (single carrier frequency division multiple access) and the like. CDMA can be implemented with such a radio technology as UTRA (universal terrestrial radio access), CDMA 2000 and the like. TDMA can be implemented with such a radio technology as GSM/GPRS/EDGE (Global System for Mobile communications)/General Packet Radio Service/Enhanced Data Rates for GSM Evolution) and the like. OFDMA can be implemented with such a radio technology as IEEE (Institute of Electrical and Electronics Engineers) 802.11 (Wi-Fi), IEEE 802.16 (WiMAX), IEEE 802.20, E-UTRA (Evolved UTRA) and the like. UTRA is a part of UMTS (Universal Mobile Telecommunications System). 3GPP (3rd Generation Partnership Project) LTE (long term evolution) is a part of E-UMTS (Evolved UMTS) that uses E-UTRA. The 3GPP LTE adopts OFDMA in DL and SC-FDMA in UL. And, LTE-A (LTE-Advanced) is an evolved version of LTE. Moreover, IEEE 802.16m is an evolved version of IEEE 802.16e.

In this specification, a terminology called radio access (multi-RAT) may be variously named such a terminology as radio communication scheme and the like.

FIG. 1 is a diagram for one example of a multi-RAT (multi-radio access technology) system.

Referring to FIG. 1, a multi-radio access technology (hereinafter abbreviated a multi-RAT) system may include a base station 100 and a plurality of communication devices 110, 120, 130 and 140.

The devices 1120, 120, 130 and 140 represented as communication devices in FIG. 1 may become a source device as a subject to communicate with a base station with helps of other user equipments connected to the source device, a cooperative device playing a role as a relay to help a source device to communicate with a base station and a cooperative device candidate except a source device playing a role as a cooperative device and the like.

In a multi-RAT system, a plurality of the communication devices 110, 120, 130 and 140 may establish a cooperative system with each other. In the cooperative system established multi-RAT system, a source device may be able to transmit data to a base station together with a cooperative device. Moreover, a source device may be able to receive data from a base station together with a cooperative device.

In this case, a direct radio communication scheme among a plurality of devices may differ from a direct radio communication scheme between a base station and a plurality of devices. In particular, data may be transceived by applying a wireless LAN access scheme (e.g., Wi-Fi, etc.) among a plurality of devices, while data may be transceived by applying a mobile communication network access scheme (e.g., IEEE 802.16 (WiMAX), etc.) between a base station and a plurality of devices.

For instance, a plurality of devices may perform a direct communication in-between by IEEE 802.11 (Wi-Fi) scheme or Bluetooth scheme. On the other hand, each of a plurality of devices may perform a direct communication with a base station by IEEE 802.16 (WiMAX) scheme.

Yet, the present invention may be non-limited by the above description and may enable a plurality of devices to communicate with each other by the same wireless or radio communication scheme.

Referring to FIG. 1, in the cooperative system established multi-RAT system, the source device 140 may be able to transmit data to the base station 100 together with the cooperative device 130. Through this, since a communication device may be able to efficiently transmit data, it may be able to secure good performance. Moreover, through the cooperative system established multi-RAT system, each device may be able to reinforce its throughput and power consumption may be reduced using a data communication via a cooperative system.

In the cooperative system established multi-RAT system, a source device may be able to transmit data to a base station via a cooperative device. And, a source device may be able to receive data from a base station via a cooperative device.

Referring to FIG. 1, in the cooperative system established multi-RAT system, the source device 100 may be able to transmit data to the base station 100 via the cooperative device 120. Through this, since a communication device may be able to efficiently transmit data, it may be able to prevent degradation of system performance.

Although FIG. 1 shows the example for a source device to transmit data to t abase station via a cooperative device, the above description may be identically applicable to a case for a base station to receive data from a source device as well.

When a different data is transmitted, referring to FIG. 1, the source device 110/140 may become a cooperative device or a neighbor device failing to join a data transmission and the cooperative device 120/130 may becomes a source device or a neighbor device failing to join a data transmission.

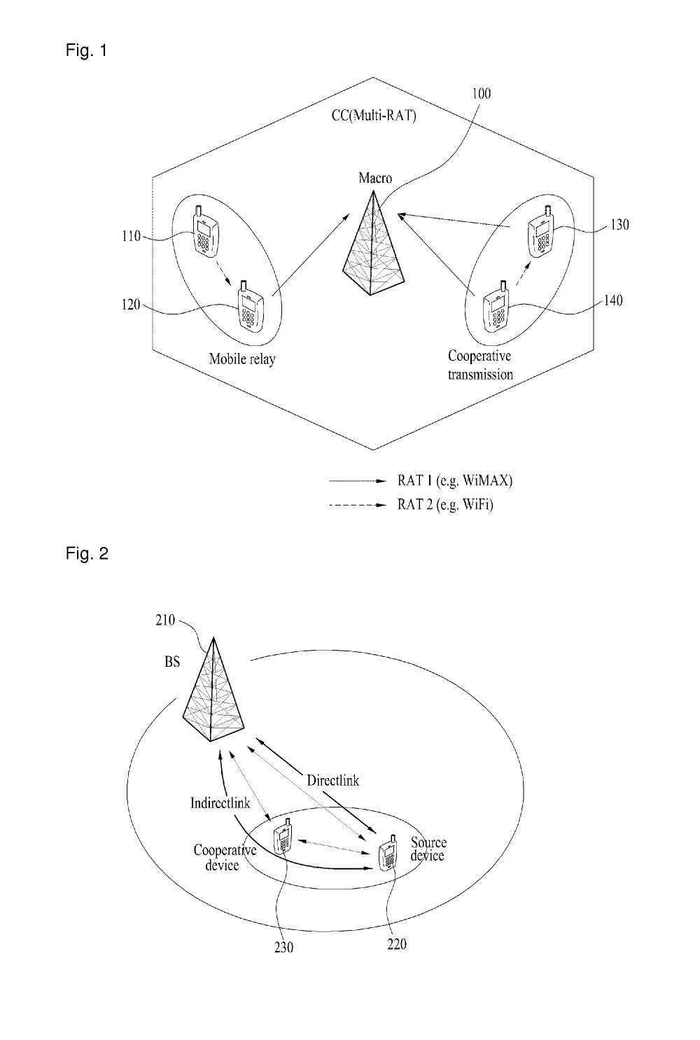

FIG. 2 is a diagram for one example of an operation of a multi-RAT (multi-radio access technology) system.

Referring to FIG. 2, a multi-RAT system may include a base station 210 and a plurality of communication devices 220 and 230.

In a multi-RAT system, a plurality of the communication devices 220 and 230 may be able to establish a cooperative system together by such a radio technology as 802.11 (Wi-Fi) and the like.

In general, each of a plurality of the communication devices 220 and 230 may be able to directly transmit/receive data to/from the base station 210 by such a radio technology as IEEE 802.16 (WiMAX) and the like.

In doing so, in case that a current communication quality of the source device 220 is abruptly lowered, it may be able to indirectly transmit data to the base station 210 via the cooperative device 230.

Thus, in a multi-RAT system, a communication device may be able to directly exchange data with a base station and may be also able to indirectly exchange data with the base station with a help of a cooperative device having a good communication quality. Therefore, degradation of system performance can be prevented and efficient data communication can be performed.

In order to transmit and receive data with the cooperation of a plurality of communication devices in a multi-RAT system, a prior procedure for exchanging information in advance may be required.

The information exchanging procedure, which should be performed between a base station and a plurality of communication devices in a multi-RAT system may mainly include 4 steps. In particular, the steps may include a general network entering step, a negotiating step for a plurality of devices to cooperate with each other, a step of searching neighbor devices of a source device and selecting a cooperative device from the searched neighbor devices, and a step of connecting to the selected cooperative device.

In the following description, a structure of a radio frame applicable to the present invention may be explained.

For clarity and convenience of the following description, a structure of a radio frame applicable in 3GPP LTE may be taken as an example, by which the present invention may be non-limited. And, various types of radio frame structures may be applicable to the present invention.

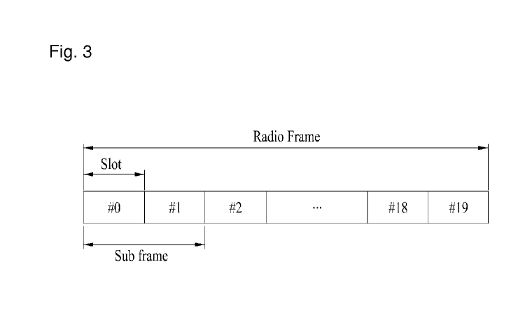

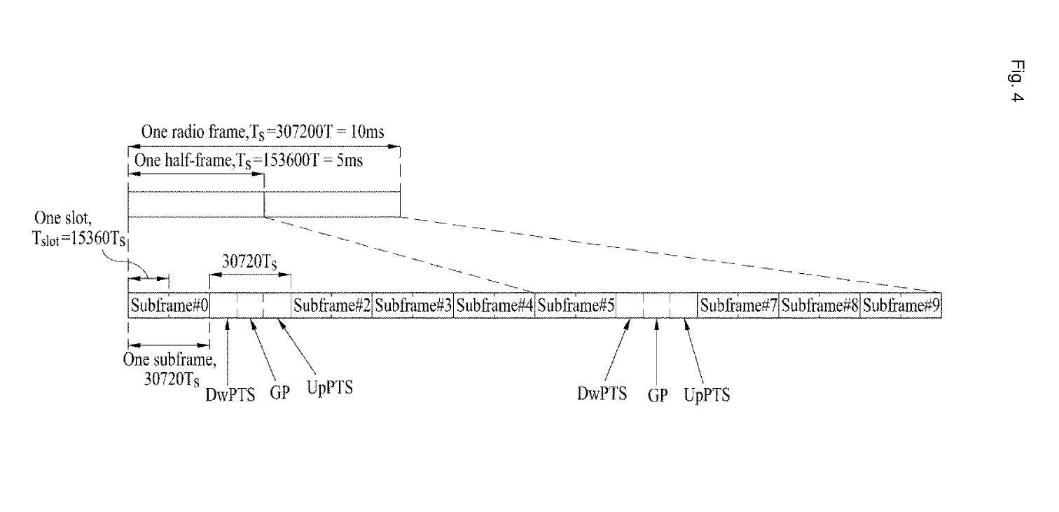

FIG. 3 is a diagram for a structure of FDD (frequency division duplex) radio frame in 3GPP LTE. This radio frame structure may be named a frame structure type 1.

Referring to FIG. 3, a radio frame may include 10 subframes and each of the subframes may be defined as 2 contiguous slots. A time taken for one subframe to be transmitted may be called a transmission time interval (TTI). A time length of a radio frame may be defined as T_{f}=307200*Tₛ=10 ms and may include 20 slots. A time length of the slot may be defined as Tₛₗₒₜ=15360*Tₛ=0.5 ms and may be numbered as 0 to 19. A downlink, in which each node or base station transmits a signal to a user equipment, may be discriminated from an uplink, in which the user equipment transmits a signal to each node or base station, in frequency domain.

FIG. 4 is a diagram for a structure of TDD (time division duplex) radio frame in 3GPP LTE. This radio frame structure may be named a frame structure type 2.

Referring to FIG. 4, one radio frame may have a length of 10 ms and may include two half-frames each of which has a length of 5 ms. One subframe may be designated as one of a UL subframe, a DL subframe and a special subframe. One radio frame may include at least one UL subframe and at least one DL subframe. One subframe may be defined as 2 contiguous slots. For instance, a length of one subframe may be 1 ms and a length of one slot may be 0.5 ms.

A special subframe is a specific period for separating an uplink and a downlink from each other between a UL subframe and a DL subframe. At least one special subframe may exist in one radio frame. And, a special subframe may include a downlink pilot time slot (DwPTS), a guard period and an uplink pilot time slot (UpPTS). The DwPTS may be used for initial cell search, synchronization or channel estimation. The UpPTS may be used for channel estimation in a base station and a UL transmission synchronization matching of a user equipment. The guard period is an interval between an uplink and a downlink to eliminate an interference generated in UL due to a multi-path delay of a DL signal.

One slot in FDD/TDD radio frame may include a plurality of OFDM (orthogonal frequency division multiplexing) symbols in time domain and may include a plurality of resource blocks (RBs) in frequency domain. Since 3GPP LTE uses PFDMA in DL, the OFDM symbol may represent one symbol period and may be called such a different terminology as SC-FDMA symbol and the like in accordance with a multi-access scheme. The resource block may include a plurality of contiguous subcarriers in one slot by a resource allocation unit.

The radio frame structures described with reference to FIG. 3 and FIG. 4 may refer to Paragraph 4.1 and Paragraph 4.2 of 3GPP TS 36.211 V8.3.0 (2008-05) “Technical Specification Group Radio Access Network; Evolved Universal Terrestrial Radio Access (E-UTRA); Physical Channels and Modulation (Release 8)”.

The above-mentioned radio frame structures may be just exemplary. And, the number of subframes included in a radio frame, the number of slots included in a subframe, the number of OFDM symbols included in a slot and the like may be modifiable in various ways.

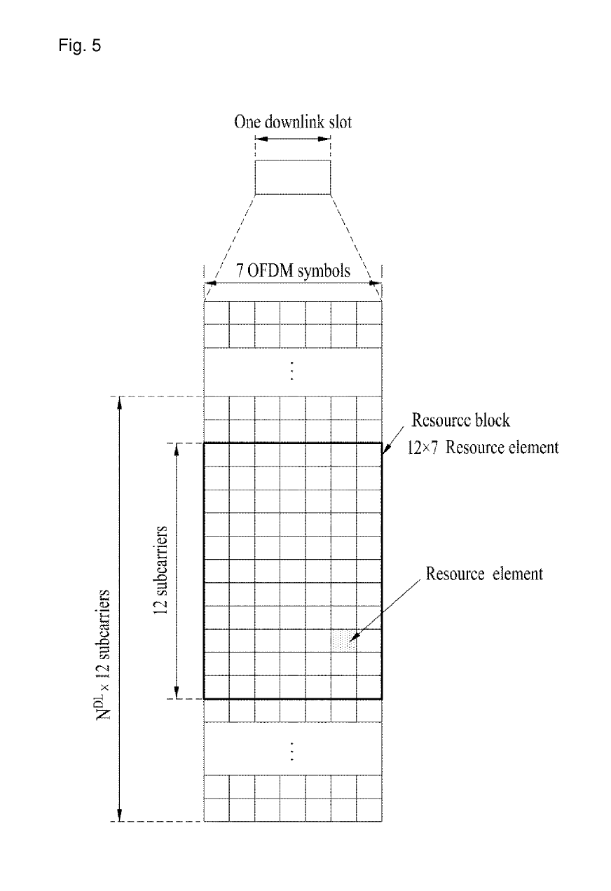

FIG. 5 is a diagram for one example of a resource grid for one downlink slot.

Referring to FIG. 5, one DL slot may include a plurality of OFDM symbols in time domain. In particular, one DL slot includes 7 OFDMA slots and one resource block (RB) includes 12 subcarriers in frequency domain, which is just exemplary and by which the present invention may be non-limited.

Each element on a resource grind may be called a resource element and one resource block (RB) includes 12 7 resource elements. The number N^{DL} of resource blocks included in a DL slot may depend on a DL transmission bandwidth set for a cell. The above-mentioned resource grid for the DL slot may be applicable to a UL slot as well.

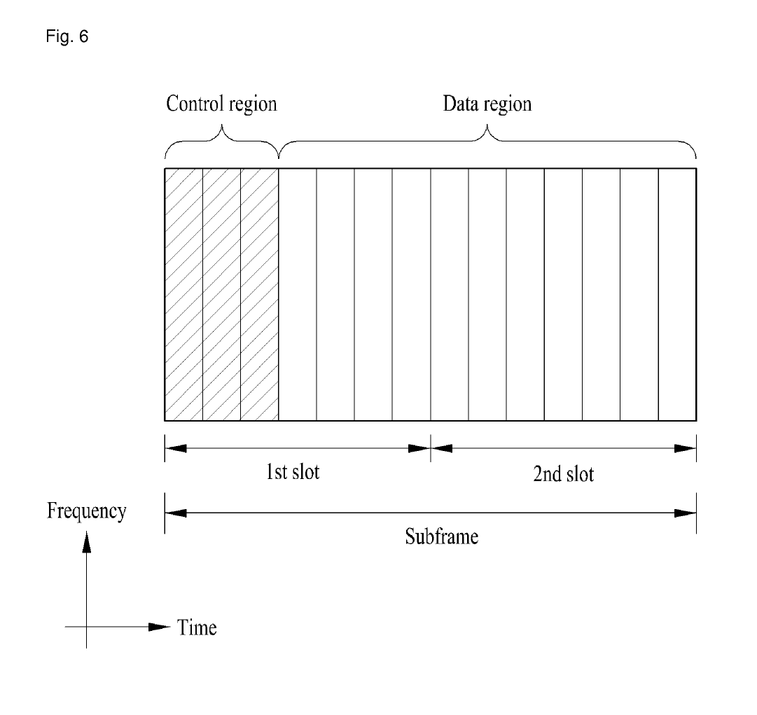

FIG. 6 is a diagram for one example of a structure of a downlink frame.

Referring to FIG. 6, a subframe may include 2 contiguous slots. Maximum 3 fore OFDM symbols of a 1^{st} slot within the subframe may correspond to a control region to which DL control channels are allocated. And, the rest of OFDM symbols may become a data region to which PDSCH (physical downlink shared channel) is allocated.

In the DL control channel, PCFICH (Physical Control Format Indicator Channel), PDCCH (Physical Downlink Control Channel), PHICH (Physical Hybrid-ARQ Indicator Channel) and the like may be included. The PCFICH carried on a 1^{st} OFDM symbol of a subframe may carry information on the number of OFDM symbols (i.e., a size of a control region) used for a transmission of control channels in the subframe. Control information carried on PDCCH may be called downlink control information (DCI). The DCI may indicate UL resource allocation information, DL resource allocation information, UL transmit power control command for random UE groups and the like. The PHICH may carry ACK/NACK (acknowledgement/negative-acknowledgement) signal for HARQ (hybrid automatic repeat request) of UL data. In particular, ACK/NACK signal for UL data transmitted by a user equipment may be carried on the PHICH.

The PDSCH is a channel that carries control information and/or data. A user equipment may be able to read data carried on the PDSCH by decoding DL control information carried on the PDCCH.

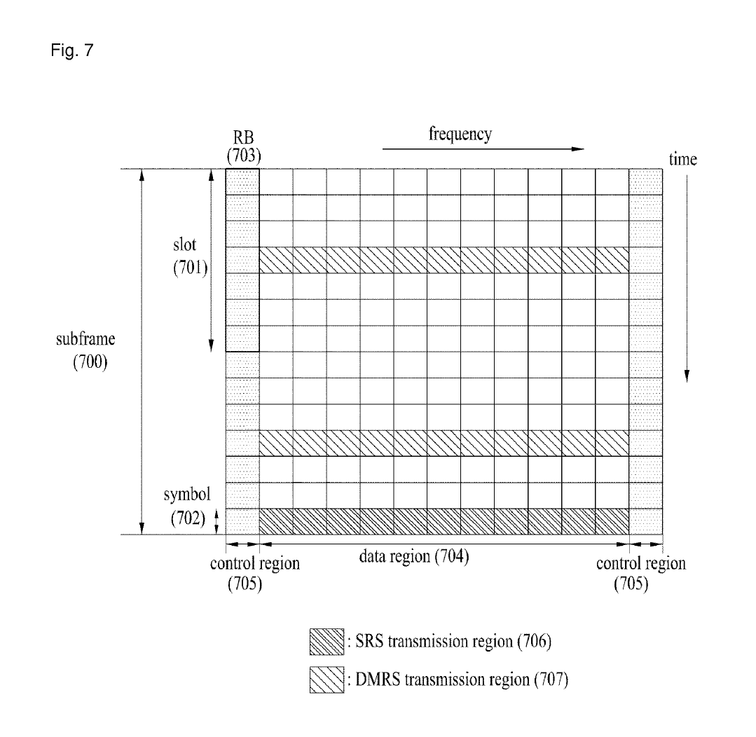

FIG. 7 is a diagram for a structure of an uplink subframe used in LTE system.

Referring to FIG. 7, a subframe 700 having a length of 1 ms, which is a basic unit of LTE UL transmission may include two 0.5 ms slots 701. Assuming a length of a normal cyclic prefix (CP), each slot includes 7 OFDM symbols 702 and one symbol corresponds to one SC-FDMA symbol. A resource block 703 is a resource allocation unit which corresponds to 12 subcarriers in frequency domain and one slot in time domain. A structure of UL subframe of LTE may be mainly divided into a data region 704 and a control region 705. In this case, the data region may mean a series of communication resources used in transmitting data of audio, packet and the like to each user equipment and may correspond to the rest of resources except the control region in the subframe. The control region may mean a series of communication resources used in transmitting a DL channel quality report from each user equipment, reception ACK/NACK for a DL signal and a UL scheduling request and the like.

According to the example shown in FIG. 7, a region 706 for transmitting a sounding reference signal in one subframe corresponds to an interval, in which an SC-FDMA symbol situated at a last position on a time axis in one subframe exists, and may be transmitted via a data transmission bandwidth on a frequency axis. Sounding reference signals of several user equipments, which are carried on last SC-FDMA in the same subframe, may be identifiable in a cyclic shift value. Moreover, a region for transmitting a DM-reference signal (demodulation-reference signal) in one subframe corresponds to an interval, in which a middle SC-FDMA symbol in one slot, i.e., 4^{th} SC-FDMA symbol and 11^{th} SC-FDMA symbol exist, and may be transmitted via a data transmission region on a frequency axis.

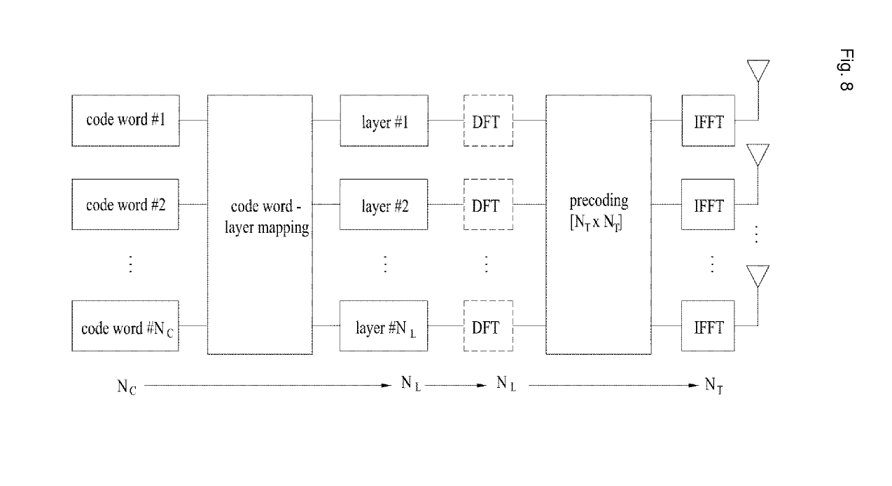

FIG. 8 is a diagram for explaining mapping relations among a code word, a layer and an antenna to transmit a downlink signal in a multi-RAT (multi-radio access technology) system.

Referring to FIG. 8, a complicated mapping relation may exist between data information and transmission symbol. First of all, a MAC (medium access control) layer may deliver N_{c} transport blocks as data information to a physical layer. In the physical layer, the transport blocks may be transformed into a code word by channel coding and such a rate matching as puncturing, repetition and the like may be performed. In doing so, the channel coding may be performed by such a channel coder as a turbo encoder, a tail bit convolution encoder and the like.

After completion of the channel coding process and the rate matching process, the N_{C} code words may be mapped to N_{L} layers. In this case, each of the layers may indicate a different information sent using MIMO technology and the number of the layers may not be greater than a rank that is the maximum number for sending different informations.

For reference, unlike such a general DL transmission scheme as OFDMA (Orthogonal Frequency Division Multiple Access), DFT may be performed on each layer for a UL signal transmitted by SC-FDMA (Single Carrier-Frequency Division Multiple Access) in order to enable a transmitted signal to have a single carrier property by canceling out an effect of IFFT (Inverse Fast Fourier Transform) in part.

The signals transformed by DFT in the layers are multiplied by a precoding matrix, are mapped to N_{T} transmitting antennas, respectively, and are then transmitted to a base station through IFFT.

Generally, a common reference signal and a UE-specific reference signal may exist in a DL reference signal and precoding may not be applied to the common reference signal. In particular, the UE-specific reference signal is precoded by being inserted into a precoding part and is then transmitted to a user equipment side, in the same manner of normal data.

In order to implement spatial multiplexing transmission non-dependent on channel using a UE-specific reference signal, i.e., a dedicated reference signal, there exist several conditions. First of all, in order to reduce signaling overhead of a reference signal, a transmission reference signal should be precoded using the same precoding matrix of a modulated data symbol. Moreover, in order to obtain spatial channel diversity, a precoding matrix should be switched between antennas. Yet, since the dedicated reference signal is transmitted across a whole transmission resource region according to a specific rule or randomly, it may not be easy to meet the above conditions. Since channel measurement is performed by a unit of a specific number of resource elements for the efficiency of the channel measurement, it may be unable to change a precoding matrix for precoding a dedicated reference signal by a resource element unit.

Meanwhile, in order for a plurality of communication devices to transmit/receive data cooperatively in a multi-RAT system, a pre-procedure for exchanging information beforehand may be required.

In each step of the information exchanging pre-procedure, each of the communication devices may enter one of three statuses including a 1^{st} status of being disconnected from each other, a 2^{nd} status of recognizing and authenticating a counterpart communication device, and a 3^{rd} status of being associated with a counterpart communication device.

This may be described in detail with reference to Table 1 as follows.

TABLE 1

| | Authentication | Association |
|---|---|---|
| 1^{st} Status | X | X |
| 2^{nd} Status | ◯ | X |
| 3^{rd} Status | ◯ | ◯ |

First of all, the 1^{st} status may mean a status that a plurality of communication devices in a multi-RAT system are not connected to each other at all. Hence, in the 1^{st} status, each source device should perform data communication with a base station in direct.

Secondly, the 2^{nd} status may mean a status that information on a counterpart communication device is obtained and that the counterpart communication device is authenticated.

For example of a method of obtaining information on a counterpart communication device, there is a passive method of receiving information on a counterpart communication device via a beacon message or an active method including the steps of sending a probe request message and receiving information on a counterpart communication device via a probe response message received in response to the sent probe request message.

Having obtained the information on the counterpart communication device, each of the communication devices may complete an authentication confirmation job by exchanging an authentication frame (e.g., authentication request and authentication response) with the counterpart communication device.

If the authentication confirmation job is completed, each of the communication devices may enter the 2^{nd} status.

Finally, the 3^{rd} status may mean a status of being associated with an authenticated counterpart communication device.

In particular, each of the communication devices may complete an association job (e.g., AID assignment, etc.) by exchanging an association frame (e.g., association request and association response) with the counterpart communication device. If the association job of a plurality of the communication devices in the radio access system is completed, the communication devices may be able to transmit and receive their data.

In the above description, the statuses of the communication devices in the respective steps of the information exchanging pre-procedure are explained. In the following description, in order to help the understanding of the present invention, the respective steps of the information exchanging pre-procedure in the radio access system including a base station may be explained in detail.

First of all, an information exchanging step, which should be performed between a base station and a plurality of communication devices in a multi-RAT system, may mainly include 4 steps. In particular, the 4 steps may include a general network entering step, a negotiating step for a plurality of devices to cooperate with each other, a step of searching neighbor devices of a source device and selecting a cooperative device from the found neighbor devices, and a step of connecting to the selected cooperative device.

For clarity and convenience of the following description, assume that a subject per step of the information exchanging pre-procedure is a source device, by which the present invention may be non-limited. And, the substance of the present invention may be applicable to a device supporting a multi-RAT system, a cooperative device, a cooperative device candidate and the like per step.

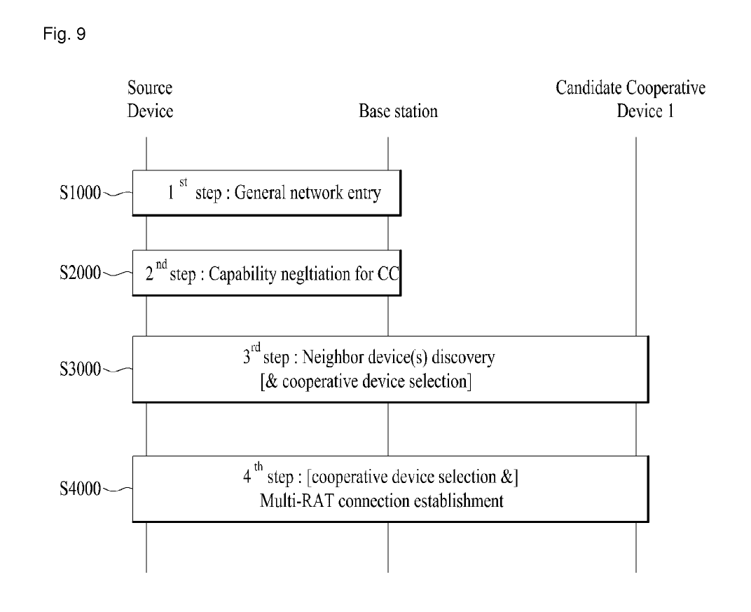

FIG. 9 is a diagram for one example of an information exchanging step requested to transmit/receive data between a base station and a plurality of devices in a multi-RAT (multi-radio access technology) system according to the present invention.

First of all, a source device may perform a general network entering step S1000 together with a base station. In particular, through the general network entering step S1000, the source device may be connected with the base station to transmit and receive data directly. For clarity and convenience of the following description, the general network entering step S1000 may be named a 1^{st} step.

Subsequently, the source device having completed the 1^{st} step together with the base station may perform a negotiating step S2000 to cooperate with a plurality of devices within the multi-RAT system. In the negotiating step S2000, the source device may negotiate with the base station for capability of a cooperative operation with the base station.

In doing so, information transceived between the base station and the source device may include connection RAT type information, system type information, system version information, location information, information on a presence or non-presence of possibility in playing a role as a cooperative device and the like.

For clarity and convenience of the following description, the negotiating step S2000 may be named a 2^{nd} step.

Having performed the 2^{nd} step, the base station, the source device and a plurality of the cooperative device candidates may perform a step S3000 of searching for neighbor devices and then selecting a cooperative device from the found neighbor devices. For clarity and convenience of the following description, assume that the step S3000 of selecting the cooperative device from the found neighbor devices may be named a 3^{rd} step.

In the 3^{rd} step, the base station, the source device and a plurality of the cooperative device candidates exchange their location informations with one another. Based on the exchanged location informations, a cooperative device to join a data communication within the multi-RAT system may be selected.

Having completed the 3^{rd} step, the source device may perform a step S4000 of connecting with the selected cooperative device. If the step S4000 of connecting with the selected cooperative device is completed, the source device and the cooperative device, which are connected to each other, may cooperatively perform data transmission/reception to/from the base station.

For clarity and convenience of the following description, the step S4000 of connecting with the selected cooperative device may be named a 4^{th} step.

In this case, each of the steps of the information exchanging pre-procedure may not be applied to all communication devices in common.

In particular, the 1^{st} and 2^{nd} steps should be performed in common by a plurality of the communication devices supporting the multi-RAT system. Yet, the 3^{rd} and 4^{th} steps may be performed by at least one of the source device, the cooperative device and the cooperative device candidate. And, it may be unnecessary for all communication devices to perform the 3^{rd} step and the 4^{th} step.

Occasionally, a portion of the 3^{rd} step (e.g., obtaining the location informations of a plurality of the communication devices supporting the multi-RAT system) may be performed in common by all communication devices.

Thus, as all communication devices supporting the multi-RAT system should perform the 1^{st} step and the 2^{nd} step, the communication devices through the 1^{st} and 2^{nd} steps may not be identifiable from each other. The communication devices may be handled as preliminary source devices and preliminary cooperative devices through the 3^{rd} step. After completion of the 4^{th} step, the source device and the cooperative device are determined. Hence, the source device and the cooperative device may cooperative with each other to transceive data with the base station.

Meanwhile, in order to perform efficient data communication with a base station, a source device may search for a plurality of cooperative device candidates capable of performing client cooperation to perform an efficient data communication with a base station and may then perform a client cooperation operation by selecting at least one cooperative device from a plurality of the found cooperative device candidates.

In doing so, since the source device has mobility, it may be necessary to periodically or aperiodically update information on a plurality of the cooperative device candidates located close to the source device. Namely, if a location of the source device or the cooperative device is changed, a plurality of the cooperative device candidates capable of performing the client cooperation previously provided to the source device ma be changed together.

In order to solve the above problem, the present invention may provide a following method. First of all, a plurality of cooperative device candidates capable of performing client cooperation transmit notification signals to indicate their existences, respectively. Secondly, a source device receives the notification signals and may be able to obtain information on a plurality of the cooperative device candidates situated close to a current location.

In the following description, a client cooperation operation or an enhanced tethering operation in a multi-RAT system may be named a CC operation.

Prior to describing a method for a plurality of cooperative device candidates to transmit notification signals to indicate their existences, respectively, a method of determining a plurality of cooperative device candidates capable of performing a CC operation with a source device may be described as follows.

First of all, a plurality of cooperative device candidates capable of performing a CC operation together with a source device may be determined by a base station.

In consideration of information (e.g., support information) on whether a CC operation may be supportable in a multi-RAT system, moving speed information (e.g., no movement, movement at low speed, etc.), location information, information on a presence or non-presence of cooperative device candidate(s) in the vicinity and the number of the cooperative device candidate(s), retained power information, channel status information (e.g., status of high quality, etc.) and the like, the base station may determine whether the corresponding device may be able to perform the CC operation together with the source device.

In doing so, only if some of a plurality of the above-enumerated informations meet the condition for performing the CC operation together with the source device, the base station may make a request for a transmission of the rest of the informations to the corresponding device.

For instance, only if a channel status of the corresponding device supporting the CC operation within the multi-RAT system is good, the base station may request the corresponding device to transmit the rest of the informations including the moving speed information, the location information, the information on a presence or non-presence of cooperative device candidate(s) in the vicinity and the number of the cooperative device candidate(s), the retained power information and the like.

In doing so, if the condition for the corresponding device to perform the CC operation together with the source device is met, when the base station determines that the CC operation is necessary, the base station may request the corresponding device to play a role as a cooperative device candidate.

Having received the request for playing the role as the cooperative device candidate, the corresponding device may accept or reject the corresponding request.

In case that the corresponding device accepts the received request for playing the role as the cooperative device candidate, the corresponding device may transmit detailed information (e.g., system type in such a radio technology as IEEE 802.11a, IEEE 802.11b, IEEE 802.11g, 802.11n, etc., system version, MAC address, information on WiFi or Bluetooth, etc.) required for performing the CC operation to the base station.

Thereafter, if the detailed information required for performing the CC operation is transmitted to the base station, the corresponding device may be able to play the role as the cooperative device candidate.

In the following description, on the assumption that a plurality of cooperative device candidates are determined by a base station, a method for a plurality of the cooperative device candidates to transmit notification signals indicating their existences to a source device may be explained in detail.

First of all, in order to avoid a problem that notification signals transmitted by a plurality of the cooperative device candidates may overlap with notification signals transmitted at the same timing point of the former notification signals by neighbor cooperative device candidates, each of a plurality of the cooperative device candidates may be able to negotiate with a base station for a transmission period of a notification signal, a transmission offset and the like. In particular, this negotiation may be performed in the course of a request process for determining each device as a cooperative device candidate.

And, a start point of a notification signal transmission period may be defined as such a specific timing point as a timing point of completing the corresponding negotiation and the like.

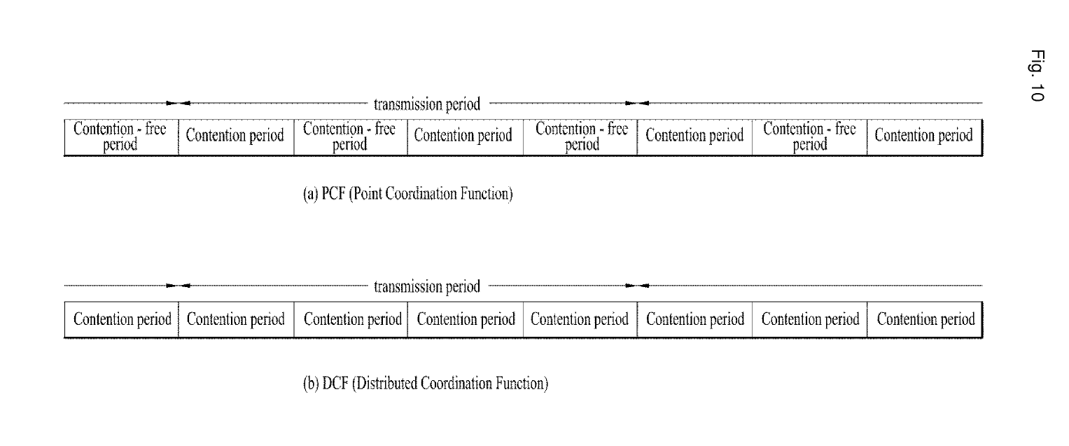

FIG. 10 is a diagram for a detailed example of a transmission period of a notification signal according to the present invention.

In particular, FIG. 10A shows a transmission period of a notification signal in accordance with PCF (point coordination function).

Referring to FIG. 10A, a whole PCF includes a plurality of transmission periods. Each of the transmission periods includes a plurality of contention periods and a plurality of contention-free periods.

In the contention period, each of a plurality of cooperative device candidates may externally transmit its notification signal freely.

Yet, in the contention-free period, a cooperative device candidate, which is designated to transmit a notification signal in the contention-free period according to a negotiation with a base station, may externally transmit its notification signal only.

Hence, the PCF (point coordination function) utilizes the contention-free period on the basis of the contention period, thereby solving the overlapping problem of the transmitted notification signals.

Besides, a notification signal may be transmittable according to DCF (distributed coordination function) including contention periods only.

Referring to FIG. 10B, a whole DCF may include a plurality of transmission periods. And, each of the transmission periods may include a plurality of contention periods.

In the contention period, each of a plurality of cooperative device candidates may externally transmit its notification signal freely.

Hence, the DCF (distributed coordination function) frequently gives opportunity for each cooperative device candidate to transmit a notification signal on the basis of the contention period, thereby enabling the notification signals to be efficiently transmitted to a source device.

In the following description, a frame of a notification signal transmitted by each of a plurality of cooperative device candidates may be explained in detail.

First of all, each of a plurality of cooperative device candidates may periodically notify its existence to other neighbor devices by multicast.

In case that WiFi technology is applied to a multi-RAT system, a notification signal transmitted by each of a plurality of cooperative device candidates may include RTS (ready to send) frame.

In particular, as mentioned in the foregoing description, in order to prevent collision or interference with a neighbor cooperative device candidate, a cooperative device candidate transmitting a notification signal may transmit a corresponding RTS at a timing point of a period for which the corresponding cooperative device candidate has negotiated with a base station.

Moreover, the corresponding cooperative device candidate may be able to determine a transmission timing point of the RTS by a conventional contention resolution method.

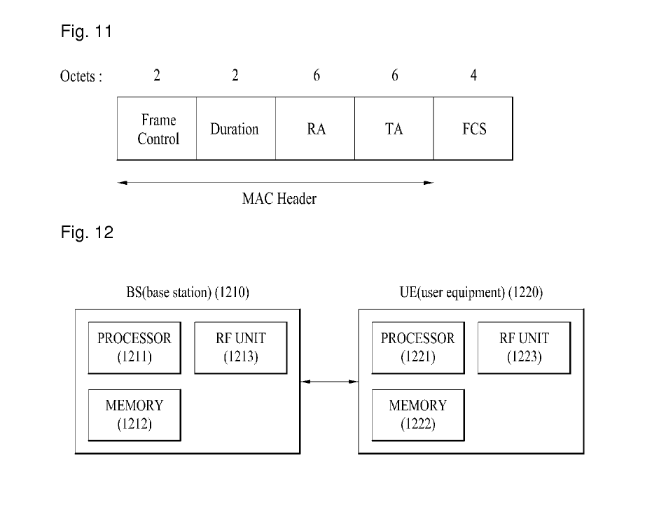

FIG. 11 is a diagram for one example of an RTS transmission frame for a notification signal in case of applying WiFi technology to a multi-RAT system according to the present invention.

First of all, an RTS transmission frame for a notification signal may include a frame control field, a duration field, an RA (receiver address) field, a TA (transmitter address) field, an FCS (frame check sum) field and the like.

In particular, the respective fields in the RTS transmission frame may be settable as follows.

First of all, the RA (receiver address) field may be set to a value of a multicast-group address to enable other devices to recognize an existence of a cooperative device candidate.

Since the multicast-group address value for the corresponding usage is previously occupied and all devices supporting a CC operation are already aware of the corresponding multicast-group address value, it can be observed that the corresponding frame is the frame containing informations (e.g., MAC address, etc.) of cooperative device candidates via the RA (receiver address) field within the RTS transmission frame.

The TA (transmitter address) field may be set to a value of a MAC address of a cooperative device candidate.

Moreover, when an RTS transmission frame is transmitted for a notification signal, since such a different operation as CTS and the like is not required, it may be able to set the duration field to 0.

Yet, the RTS transmission frame described with reference to FIG. 11 is just one example of a frame to transmit a notification signal and may have another type.

For instance, a frame for transmitting a notification signal may include a frame control field, an RA (receiver address) field, a TA (transmitter address) field and an FCS (frame check sum) field only.

Moreover, the RST transmission frame may be utilized in case of assuming a case of applying WiFi technology to a multi-RAT system. In case that such a radio technology as IEEE 802.16 (WiMAX), IEEE 802.20, E-UTRA (evolved UTRA) and the like is applied, it may be able to utilize a notification signal transmission frame of a different type.

In the following description, a method for another device to monitor a notification signal may be explained in detail.

First of all, a general device (e.g., a source device) supporting a CC operation may monitor a notification signal transmittable from a neighbor cooperative device candidate.

In doing so, the source device may be able to periodically perform an operation of monitoring a notification signal to retain a latest information list of neighbor cooperative device candidates.

In case that WiFi technology is applied to a multi-RAT system, the source device may receive an RTS transmission frame, in which a multicast-group address) value is set for an RA (receiver address) field in association with a notification signal.

In case that a notification signal is received via an RTS transmission frame, a source device may not transmit CTS to each device having a TA (transmitter address) field in the RTS transmission frame.

In doing so, the source device may update a cooperative device candidate information list for performing the CC operation using the TA (transmitter address) field in the received RTS transmission frame.

If the source device does not receive a notification signal for a preset period from a cooperative device candidate included in the previous cooperative device candidate information list, the source device may be able to remove the cooperative device candidate, of which notification signal is not received, from the list.

The source device may periodically report a latest cooperative device candidate information list to the base station or may report it in response to a request made by the base station.

In case of determining that there is a modified item exists in the received information list, the base station may transmit the modified item to the corresponding source device.

Therefore, since a source device having mobility may be able to periodically or aperiodically update information on a plurality of cooperative device candidates located close to the corresponding source device via notification signals, the corresponding source device may be able to smoothly perform a client cooperation (CC) operation.

FIG. 12 is a block diagram of configurations of a base station apparatus 1210 and a communication apparatus 1220 supporting a multi-RAT system according to one preferred embodiment of the present invention. So far, in the above description, such a terminology as a user equipment, a communication device and a communication apparatus has been interchangeably used. Yet, in order to prevent the confusion in using the terminology, such a terminology may be named a user equipment apparatus in the following description.

Referring to FIG. 12, a base station apparatus 1210 according to the present invention may include a receiving module 1211, a transmitting module 1212, a processor 1213, a memory 1214 and a plurality of antennas 1215. A plurality of the antennas 1215 may mean the base station apparatus supporting MIMO transmission and reception. The receiving module 1211 may be able to receive various signals, data and informations in UL from a user equipment. The transmitting module 1212 may be able to transmit various signals, data and informations in DL to the user equipment. And, the process 1213 may be able to control overall operations of the base station apparatus 1210.

The processor 1213 of the base station apparatus 1210 may be able to determine a plurality of cooperative device candidates capable of performing CC operation together with a source device. In particular, in consideration of information (e.g., support information) on whether a CC operation may be supportable in a multi-RAT system, moving speed information (e.g., no movement, movement at low speed, etc.), location information, information on a presence or non-presence of cooperative device candidate(s) in the vicinity and the number of the cooperative device candidate(s), retained power information, channel status information (e.g., status of high quality, etc.) and the like, the processor 1213 of the base station apparatus 1210 may determine whether the corresponding device may be able to perform the CC operation together with the source device.

The processor 1213 of the base station apparatus 1210 may also perform a function of operating information received by the base station apparatus 1210, information to be transmitted by the base station apparatus 1210 and the like. And, the memory 1214 may be able to store the operated information and the like for prescribed duration and may be substituted with such a component as a buffer (not shown in the drawing) and the like.

Referring to FIG. 12, a user equipment apparatus 1220 according to the present invention may include a receiving module 1221, a transmitting module 1222, a processor 1223, a memory 1224 and a plurality of antennas 1225. A plurality of the antennas 1225 may mean the user equipment apparatus supporting MIMO transmission and reception. The receiving module 1221 may be able to receive various signals, data and informations in DL from a base station. The transmitting module 1222 may be able to transmit various signals, data and informations in UL to the base station. And, the process 1223 may be able to control overall operations of the user equipment apparatus 1220.

The processor 1223 of the user equipment apparatus 1220 may be able to control, in order to prevent collision or interference with a neighbor cooperative device candidate, a corresponding notification signal to be transmitted at a timing point of a period for which the user equipment apparatus 1220 has negotiated with the base station.

The processor 1223 of the base station apparatus 1220 may monitor a notification signal transmittable from a neighbor cooperative device candidate. In doing so, the processor 1223 of the user equipment apparatus 1220 may control the notification signal monitoring operation to be periodically performed to retain a latest information list of cooperative device candidates.

The processor 1223 of the user equipment apparatus 1220 may also perform a function of operating information received by the user equipment apparatus 1220, information to be transmitted by the user equipment apparatus 1220 and the like. The memory 1224 may be able to store the operated information and the like for prescribed duration and may be substituted with such a component as a buffer (not shown in the drawing) and the like.

The above-described detailed configurations of the base station apparatus and the user equipment apparatus may be implemented in a manner that the above-mentioned descriptions of the embodiments of the present invention are independently applied or that at least two of the embodiments of the present invention are simultaneously applied. And, the redundant contents may be omitted for clarity.

In the description with reference to FIG. 12, the description of the base station apparatus 1210 may be identically applicable to a relay apparatus as a DL transmission subject or a UL reception subject. And, the description of the user equipment apparatus 1220 may be identically applicable to a relay apparatus as a DL reception subject or a UL transmission subject.

Embodiments of the present invention can be implemented using various means. For instance, embodiments of the present invention can be implemented using hardware, firmware, software and/or any combinations thereof.

In case of the implementation by hardware, a method according to each embodiment of the present invention can be implemented by at least one selected from the group consisting of ASICs (application specific integrated circuits), DSPs (digital signal processors), DSPDs (digital signal processing devices), PLDs (programmable logic devices), FPGAs (field programmable gate arrays), processor, controller, microcontroller, microprocessor and the like.

In case of the implementation by firmware or software, a method according to each embodiment of the present invention can be implemented by modules, procedures, and/or functions for performing the above-explained functions or operations. Software code is stored in a memory unit and is then drivable by a processor. The memory unit is provided within or outside the processor to exchange data with the processor through the various means known in public.

As mentioned in the foregoing description, the detailed descriptions for the preferred embodiments of the present invention are provided to be implemented by those skilled in the art. While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents. For instance, the respective configurations disclosed in the aforesaid embodiments of the present invention can be used by those skilled in the art in a manner of being combined with one another. Therefore, the present invention is non-limited by the embodiments disclosed herein but intends to give a broadest scope matching the principles and new features disclosed herein.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents. And, it is apparently understandable that an embodiment is configured by combining claims failing to have relation of explicit citation in the appended claims together or can be included as new claims by amendment after filing an application.

### INDUSTRIAL APPLICABILITY

The present invention may be applicable to such a system as a multi-RAT system, a wireless communication system and the like. In particular the present invention may be applicable to a wireless mobile communication apparatus used for a cellular system.

1. A method of performing a communication, which is performed by a user equipment supporting a Multi-RAT (Radio Access Technology), comprising the steps of:
receiving a notification signal indicating an existence of at least one cooperative user equipment candidate from the at least one cooperative user equipment candidate for a client cooperation (CC) via a 1^{st} radio access scheme; and
transmitting a 1^{st} data to a base station using at least one cooperative user equipment connected via the received notification signal among the at least one cooperative user equipment candidate,
wherein the 1^{st} data is exchanged between the user equipment and the at least one cooperative user equipment via the 1^{st} radio access scheme and
wherein the 1^{st} data is exchanged between the at least one cooperative user equipment and the base station via a 2^{nd} radio access scheme.

2. The method of claim 1, further comprising generating and updating a list of cooperative user equipment candidates for the CC based on the notification signal.

3. The method of claim 2, further comprising reporting the list of the cooperative user equipment candidates to the base station.

4. The method of claim 2, wherein if the notification signal is not received from the at least one cooperative user equipment candidate for predetermined period, deleting the at least one cooperative user equipment candidate from the list of the cooperative user equipment candidates.

5. The method of claim 1, wherein the at least one cooperative user equipment candidate is determined by the base station using at least one selected from the group consisting of information on whether a client cooperation operation is be supportable, moving speed information, location information, information on a presence or non-presence of neighbor cooperative user equipment candidate(s) in the vicinity and the number of the neighbor cooperative user equipment candidate(s), retained power information, and channel status information.

6. (canceled)

7. The method of claim 1, wherein the notification signal is received as a type of an RTS (ready to send) frame including an RA (receiver address) field and a TA (transmitter address) field, wherein the RA field is set to an address value previously assigned to discriminate the at least one cooperative user equipment candidate from each other, and wherein the TA field is set to a MAC (medium access control) address value of each of the at least one cooperative user equipment candidate.

8-10. (canceled)

11. The method of claim 1, a transmission of the notification signal from the at least one cooperative user equipment candidate is triggered by an activation request message for the CC.

12. The method of claim 1, wherein the notification signal is received according to information about transmission periods for the notification signal,
wherein the information about transmission periods for the notification signal is determined by a point coordination function (PCF) or a distributed coordination function (DCF), the PCF consists of contention periods and contention-free periods, the DCF consists of contention periods.

13. (canceled)

14. A method of performing a communication, which is performed by a base station supporting a multi-RAT (multi-radio access technology, comprising the steps of:
transmitting an activation request message for a client cooperation (CC) to at least one cooperative user equipment candidate via a 2^{nd} radio access scheme; and
receiving a 1^{st} data using at least one cooperative user equipment connected to the user equipment via a notification signal for the client cooperation (CC) among the at least one cooperative user equipment candidate,
wherein the 1^{st} data is exchanged between the user equipment and the cooperative user equipment via a 1^{st} radio access scheme and
wherein the 1^{st} data is exchanged between the at least one cooperative user equipment and the base station via the 2^{nd} radio access scheme.

15. (canceled)

16. The method of claim 14, wherein the at least one cooperative user equipment candidate is determined by the base station using at least one selected from the group consisting of information on whether a client cooperation operation is be supportable, moving speed information, location information, information on a presence or non-presence of neighbor cooperative user equipment candidate(s) in the vicinity and the number of the neighbor cooperative user equipment candidate(s), retained power information, and channel status information.

17. The method of claim 14, further comprising transmitting information about transmission periods for the notification signal of the at least one cooperative user equipment candidate to the at least one cooperative user equipment candidate via the 2^{nd} radio access scheme, wherein the notification signal of the at least one cooperative user equipment candidate is differentiated according to the information about transmission periods.

18. A user equipment, which supports a Multi-RAT (Radio Access Technology, comprising:
a receiving module receiving a notification signal indicating an existence of at least one cooperative user equipment candidate from the at least one cooperative user equipment candidate for a client cooperation (CC) via a 1^{st} radio access scheme;
a transmitting module transmitting a 1^{st} data to a base station using at least one cooperative user equipment connected via the received notification signal among the at least one cooperative user equipment candidate; and
a processor controlling the 1^{st} data to be exchanged between the user equipment and the at least one cooperative user equipment via the 1^{st} radio access scheme, the processor controlling the 1^{st} data to be exchanged between the at least one cooperative user equipment and the base station via a 2^{nd} radio access scheme.

19. (canceled)

20. A base station, which supports a Multi-RAT (Radio Access Technology), comprising:
a transmitting module transmitting an activation request message for a client cooperation (CC) to at least one cooperative user equipment candidate via a 2^{nd} radio access scheme;
a receiving module receiving a 1^{st} data using at least one cooperative user equipment connected to the user equipment via a notification signal for the client cooperation (CC) among the at least one cooperative user equipment candidate; and
a processor controlling the 1^{st} data to be exchanged between the user equipment and the cooperative user equipment via a 1^{st} radio access scheme, the processor controlling the 1^{st} data to be exchanged between the at least one cooperative user equipment and the base station via the 2^{nd} radio access scheme.

21. The method of claim 14, wherein the information about transmission periods for the notification signal is determined by a point coordination function (PCF) or a distributed coordination function (DCF), the PCF consists of contention periods and contention-free periods, the DCF consists of contention periods.
